(19) United States
(12) Patent Application Publication
(10) Pub. No.: US 2008/0163450 A1
(43) Pub. Date: Jul. 10, 2008

(54) Wide path leaf blower attachment

(76) Inventor: Richard John Disanto, Mountain Home, AR (US)

Correspondence Address: Richard J. DiSanto, 104 Castle Hill Drive, Mountain Home, AR, 72653, US

(21) Appl. No.: 11/644,778

(22) Filed: Dec. 21, 2006

(51) Int. Cl. A01D 7/00

(52) U.S. Cl. 15/405; 56/12.8

(57) ABSTRACT

This is a leaf blower attachment which can be used with nearly any hand-held or back-pack type of leaf blower commonly on the market today, either electric or gas powered. It is designed for the purpose of clearing a six foot wide path of leaves from driveways, walkways or lawns by simply pushing the assembled unit (leaf blower and attachment) straight ahead with not much more effort than pushing a grocery shopping cart. This is accomplished by connecting nearly any make/brand/model of available market leaf blowers to my invention by either inserting the blower discharge tube directly into the attachment, or by means of utilizing a specific manufacturer's adapter fitting, if necessary. Because the attachment carries the entire weight of the blower head, it can be used efficiently, safely and easily by both the very young (as tested by an eight year old boy) and the elderly (as tested by an 81 year old woman). It eliminates both the need to swing a leaf blower from side to side, or carry the weight of a leaf blower. In the event someone who is handicapped has the desire to be self-sufficient and would like to clear leaves by themselves, my invention provides a motorized version which can be powered by two 6-12 volt variable speed/reversible electric motors controlled by using a dual radio controller. This optional equipment is commonly available (i.e.: radio controlled toys) and can be easily combined with my invention.

### BACKGROUND OF INVENTION

The claimed invention relates to a leaf blower attachment used to clear a six foot wide path of leaves from driveways, walkways and lawns without the need to swing a blower from side to side or carry the weight of a leaf blower. It comprises an electrical or gasoline powered air blower, commonly used in yard work, in combination with a series of assembled tubes, fittings and wheels. This combination is used to blow a wide path of leaves with a minimum of effort. The wide path attachment, in effect, transfers the present method of a single air flow source to a manifold system which displaces the air flow across a wide area without any appreciable loss in velocity.

### PRIOR ART

The most commonly used method of clearing leaves is to hand-carry a leaf blower and use a side to side swinging motion to achieve the goal. This can be both tiring and physically challenging to some users, especially the very young or the very old customer. This invention eliminates both conventional requirements of swinging and carrying a hand-held leaf blower and meets, or exceeds the desired results quickly and effortlessly.

### SUMMARY

The objective of the claimed invention is to offer an attachment/apparatus which, when used in conjunction with nearly any make/model of commercially available leaf blowers, will provide a simple, effortless method of clearing a six foot wide path of leaves from driveways, walkways and lawns. This objective was accomplished by inserting/mounting the discharge end of a leaf blower into the inlet end of the assembled attachment. The air provided by the blower is channeled through the 3″ I.D. tube to a horizontal manifold of like size and material which provides an evenly distributed flow of high-velocity air to clear the leaves. The horizontal manifold tube is supported by an eight inch diameter wheel fixed at each end. The inlet tube is supported by a vertical tube of like size and material which incorporates, at the bottom end cap, a five inch diameter wheel which can pivot/swivel 360 degrees and supports the full weight of the blower and provides easy steering of the entire unit. Two ½ inch metal stabilizer bars provide rigidity from the support tube to the horizontal manifold tube. Because all materials are thin wall plastic tubes supported by plastic wheels, the result is a lightweight, easy to maneuver unit which allows the user to clear a substantial area of leaves with minimum effort.

### BRIEF DESCRIPTION OF SEVERAL VIEWS OF THE EQUIPMENT

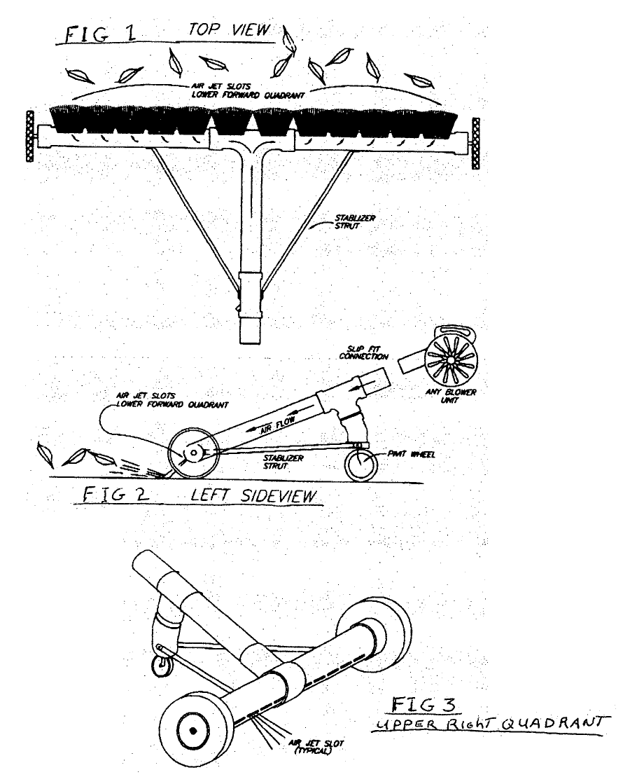

FIG. 1 is a top view showing the proof of concept model of the wide path leaf blower attachment.

FIG. 2 is a left side view which indicates the configuration of the attachment and its conjunctive use of a blower unit which provides the air which is transferred to the lower air distribution manifold and also identifies the vertical support tube and pivot wheel locations.

FIG. 3 is a view from the above right quadrant and is a general view which depicts the overall assembled attachment with the location of the two main wheels, vertical support tube and pivot wheel, ½″ stabilizer tubes and typical jet slot (air discharge) configuration.

### DESCRIPTION OF THE INVENTION

The proof of concept model of the wide path leaf blower attachment is shown in FIGS. 1, 2 and 3 wherein a electric or gasoline powered is inserted into the supply tube and channeled downward into a horizontal air manifold which displaces the high velocity air through a series of discharge air slots located on the lower front quadrant of the manifold. This action enables the user to clear a six foot wide path of leaves by simply pushing the combined unit straight ahead without the need to either swing the leaf blower from side to side or carry any weight of the leaf blower. The aforementioned air manifold section is supported by two main wheels, one mounted on each end of the manifold tube. Supporting the weight of the leaf blower is a near vertical tube of like material which has, mounted at the bottom, a 360 degree swivel/pivot wheel which, in addition to supporting the total weight, provides the steering of the combined unit by the user.

The claimed invention as shown in FIG. 1 is a top view which indicates the basic configuration of the supply tube, air manifold, main wheel location, typical air slot arrangement, stabilizer tubes and assembly fittings. All fittings can be of the “twist lock” type which would provide ease of shipping and the ability for the user to disassemble and store when not in use.

The air blower as shown in FIG. 2 can be gasoline or electrically powered and can be purchased as an off-the-shelf item from most hardware and home building stores. The suggested blower consists of a housing, power unit, fan, air inlet, air outlet a tube which can be either inserted in the claimed attachment or connected by a manufacturer's adapter. The handle configuration inherent on all said air blowers is used to grasp while pushing the combined unit and provides an ideal point from which to steer and control direction. Optimum results are obtained when using an air blower with a rated air velocity of 190 MPH or greater.

FIG. 3 shows a general configurative view of the proof of concept model to establish the typical locations of the assembled attachment, less the air blower. The overall length of the manifold and wheel section is six feet, four inches wide. The horizontal supply tube is three and one half feet in length and is situated whereas the upper end is approximately twenty six inches from the ground. The vertical support tube is approximately twenty four inches in length and incorporates a 22 degree angle fitting to position the pivot wheel at a level plane.

The materials used in the proof of concept prototype was three inch inside diameter thin wall PVC tube, compatible tee, end cap and elbow fittings, two eight inch plastic main wheels with rubber tread, one five inch 360 degree swivel/pivot plastic wheel with rubber tread and two one-half inch metal tubes, approximately thirty inches long each which serve as stabilizers.

In production, the actual materials as described and used in the proof of concept prototype could be replaced with any suitable lightweight materials, in similar configurations.

### Basic Construction and Description of the Attachment:

Basic material used is 3″ I.D. thin wall plastic pipe (i.e. PVC drain pipe) with a wall thickness of between ⅛^{th} and 3/16^{th}″, in the following configuration:
2 three foot lengths of pipe attached together with a suitable plastic “T” fitting. Nine ¼″×6″ slots for air discharge are cut horizontally along the front lower quadrant at 1 inch intervals between each slot creating a manifold. In production, variations in the number, length or size of the actual slots could vary.
At the outer ends of the pipes, end caps with a ½″ drilled, centered hole provides the mounting for a standard 8″ lawnmower wheel on each outer end by using a standard ½″×2½″ bolt with an outer flat washer and jam nut and a washer and stop (lock) nut inside. The wheel assembly is then attached to each of the two outer ends of the pipes.
attached to the remaining 3″ opening of the center “T” fitting is a two foot long piece of 3″ I.D. plastic pipe.
Another “T” fitting is then attached with the teed opening facing down and the straight through end in line with the pipe it is connected to.
Another 3″×1 foot piece of plastic pipe is connected to the “down” outlet of the “T”.
This is followed by a 22½ degree elbow at the bottom which provides for the attachment of a 5″ diameter, 360 degree swivel wheel. This wheel is attached in the same manner of the main 8″ wheels. The purpose of this wheel is to support the weight of the leaf blower head and provide easy steering and maneuvering of the combined unit.
A 3″ I.D. piece of plastic pipe is then attached to the upper “T” fitting to provide an adapter (individual leaf blower manufacturer) to connect the leaf blower to the attachment. (Most leaf blowers can simply be inserted into the pipe, or, fastened by various means.
Two lengths of thin-wall metal tubing stabilizers are added as braces to strengthen the attachment. (½″ metal conduit tube was used on the prototype). These stabilizers are connected with #8×½ sheet metal screws near where the swivel/pivot wheel is mounted and extend forward to fasten to the rear of the horizontal main 3″ pipe, using two #8×½″ sheet metal screws, at an appropriate angle to provide optimum support (per drawing).
Although my prototype was built with permanently connected (glued) pipes and fittings, the actual invention is intended to be assembled using “twist-lock” fittings and a #6×½″ sheet metal screw at each joint to prevent fittings from unlocking during use. This provides two purposes:
   1. Easier and less expensive manufacturer's packaging and shipping.
   2. Ease of disassembly and storing during off-seasons for consumer.

I claim;

1. A light weight, easy to control attachment/apparatus comprising a series of tubes, fittings and wheels creating a supply tube, manifold tube and support tube which, when used in conjunction with nearly any gas or electric powered leaf blower, enables the user to clear a six foot wide path of leaves from driveways, walkways and lawns by simply pushing the combined unit straight ahead.

2. The apparatus as claimed in claim 1 wherein said leaf blower is a commercially available blower including a housing, electrical or gas power unit, a blower fan, air inlet and outlet which interfaces with the above wide path attachment.

3. The apparatus as claimed in claim 1 wherein the user, without the need to swing a conventional leaf blower from side to side, or carry the weight of said leaf blower, has the capability to clear a wide path of leaves while simply walking in a straight line behind and guiding the apparatus, thence greatly enhancing operational flexibility and ease of use.

4. The apparatus as claimed in claim 1 wherein one end of said lightweight attachment is connected with said leaf blower discharge end, the combined unit provides sufficient air flow and velocity to be discharged through the manifold section of the apparatus to obtain the desired leaf clearing results.

5. The apparatus as claimed in claim 4 has been designed for ease of use by any age group, but is especially beneficial for use by the elderly. (The effort needed to operate the wide path leaf blaster takes about the same exertion as pushing a shopping cart, as stated by a petite 81 year old woman during testing of the prototype invention.)

6. The apparatus as claimed in claim 3 wherein the inherent handle configuration of said commercially marketed leaf blowers, used in conjunction with the attachment, is also used to steer and guide the combined unit, increasing the ease and usability of clearing said leaves.
